(19) United States
(12) Patent Application Publication
(10) Pub. No.: US 2007/0036123 A1
(43) Pub. Date: Feb. 15, 2007

(54) Wireless communications system

(75) Inventors: Simon Martin, Daniel Armour, Bristol (GB); Khurram Ali Rizvi, Bristol (GB); Dharmayashdev Rai Basgeet, Bristol (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/414,382

(22) Filed: May 1, 2006

(30) Foreign Application Priority Data
Jun. 29, 2005 (GB) 0513329.3

(51) Int. Cl. H04B 7/208

(52) U.S. Cl. 370/344; 455/449

(57) ABSTRACT

A communication network comprises at least a first region serviced by a base station. This region also comprises a plurality of bridging stations deployed around the base station, so defining a circumference around it. Each bridging station comprises one or more directional antennas operable to generate a coverage area lying predominantly outside said circumference. The effect is to form, in operation, an outer zone predominantly outside said circumference serviced by said bridging stations, and an inner zone within said circumference serviced by said base station. For communications with the outer zone, said base station is operable to assign duplicate OFDMA sub-channels to mobile stations in respective areas of the outer zone served by bridging stations that experience sufficiently low levels of cross-interference from each other's communications.

The present invention concerns communication of information within a wireless communications system. The invention is particularly, but not exclusively, concerned with the capacity of wireless communications systems in which data is transmitted in a cellular network.

The third generation (3G) collection of telecommunications standards, established in 1998 and managed by the European Telecommunications Standards Institute (ETSI), represent telecommunications implementations that offer facility for transfer of data in packet formats. The essence of the 3G Standard is that the packet format allows transfer of data, regardless of its nature. Thus, voice data and information based data can equally be transferred. Further, multimedia data can be transferred, as it is capable of being placed in a packet form and transferred accordingly.

In view of the general desire by users for transfer of increasing quantities of multimedia data, and/or voice data, with improved quality of service, there is a general and continuing requirement to seek improvements to present systems to enable greater throughput of packet data in a system.

In particular, a further portfolio of standards is currently in development, which is provisionally known as 4G (fourth generation). 4G is intended to extend 3G capacity by at least one order of magnitude, and to offer an entirely packet switched network. Whereas 3G is at least partially backwards compatible and thus 3G networks often include equipment compliant with previous, possibly non-packet based, standards, 4G network elements are intended to be entirely packet based. The data rate available in 4G is expected to be 100 Mbps (for high mobility users), and it is expected that this will develop to offer up to 1 Gbps (for low mobility users).

The latter figure is most likely to be offered in respect of mobile devices in use by pedestrians, rather than those in use in motor vehicles. This is because relatively rapid movement of a mobile device may compromise data rates.

Clearly, developments in the field of telecommunications are normally expected to result in further increases in data throughput, and so no upper limit on the performance of the present invention can be inferred from the current understanding of the targets currently stated as being attainable.

Within this context, the field of the present invention will now be described with reference to mobile communications systems based on a cellular structure. A cellular structure is imposed in order to provide coverage and capacity to users of mobile devices in the geographical area covered by the mobile communications service (the service area). Generally, a mobile communications system is designed such that, at any point in the service area, communication can be established between a base station and a mobile station within the service area. This is achieved by positioning base stations, perhaps in a regular pattern, or as near as possible taking into account physical features on the landscape, such that base stations generally govern respective cells of the cellular structure. The base stations are connected together to form a network backbone. This backbone is typically implemented by hard-wired connections.

In order for a mobile communications system to be useful, a minimum standard of quality of service must be offered to a subscriber. This entails satisfying various technical criteria in the nature of the communications between mobile stations and base stations in the system. Among these criteria are the coverage (i.e. the extent of the service area) and the capacity of the system. A subscriber will be dissatisfied with the quality of service if, while travelling, the mobile station enters a region with little or no coverage provided by communication with base stations and/or relays. Furthermore, a subscriber will also become dissatisfied if, when requesting a connection of a telephone call, the network is at capacity.

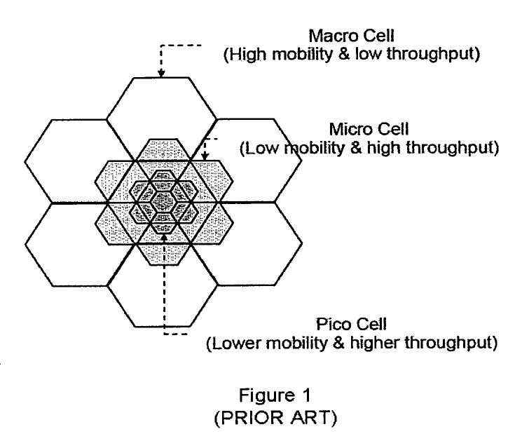

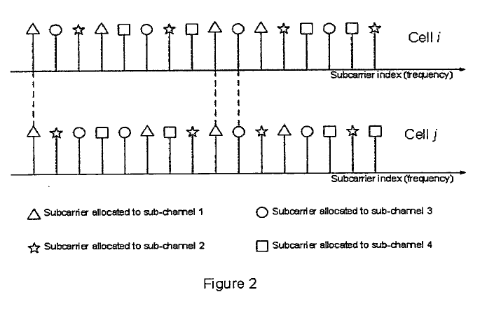

FIG. 1 illustrates an exemplary embodiment of an arrangement compliant with the 3G standard to provide improved coverage and enhanced capacity. It comprises, as illustrated, base stations (not shown), each base station having a beam pattern that, by convention is illustrated as substantially hexagonal (by virtue of six angularly spaced antennas). By virtue of these hexagonal beam patterns, a cellular field pattern can be established by virtue of regularly spaced base stations. This defines a wider, macro cell structure covering the service area. The macro cell provides the facility for communication between the base station of that cell and mobile stations within that cell with high levels of mobility but potentially low throughput of data. On top of that, a further array of base stations is deployed, each station offering a smaller coverage area. Again, in this exemplary arrangement, these smaller coverage areas are substantially hexagonal, so providing micro cells. A micro cell is characterised as offering higher throughput of data than in the macro cell, but at the expense of mobility of mobile stations within the micro cell. That is, micro cells are smaller, leading to more frequent instances of handover from one micro cell to another for a mobile station travelling at a given speed. Yet a further layer of cellular structure, with cells being still smaller than the micro cells, are provided by a further deployment of base stations. These cells are therefore termed picocells. Again, these further suffer with regard to mobility of mobile stations, in that the number of handovers required for a mobile station travelling at a given speed is far greater than with regard to a macro cell structure, but the intensity of transmission, and the adjacency to a base station allows greater throughput of data.

Therefore, the major disadvantages of this approach are the substantial increase in the cost of infrastructure due to the additional deployment of base stations on the network backbone, increased network structure due to the need to effect communication between the additional base stations, and the organisational requirements relating to the arrangement of base stations into macro-, micro- and pico-cell networks, and that throughput of data is variably limited, offering 384 Kbps for vehicle based mobile stations and 2 Mbps for stationary and near stationary mobile stations. Moreover, there is substantial signalling traffic on the backbone due to the handovers between cells and between overlapping layers of the cell hierarchy.

In addition, the wireless medium which is used in a mobile communications system with this cellular structure is somewhat unpredictable. This is due to the existence of multi-path effects brought about by the presence of physical structures in the landscape such as buildings and topographical features. Multi-path propagation can be deleterious to the successful operation of wireless communications in such a system, as it adds noise to a signal in the form of echoes of the signal itself. This noise can be sufficient to cause the termination of an active session such as a telephone call or streaming video. Such termination is highly undesirable from the point of view of the provider of a network service (the network operator) and certainly unacceptable from the point of view of the user of a mobile telephone device (the subscriber).

To address the problem of multi-path propagation and its impact on the quality of service experienced by a subscriber, it is known for a network operator to employ one or more relays, or repeaters. It will be appreciated that the terms ‘relay’ and ‘repeater’ are used interchangeably within the existing literature. These are positioned with respect to the base stations in the service area, in order to extend the coverage of the cellular parts of the service area associated with the base stations, so as to enhance the connectivity between the mobile station and the base station. A relay operates on the basis of blindly relaying received signals toward its respective base station. That is, a relay does not perform a decoding function and so cannot enhance any quality of service characteristics associated with the received data at the relay. Thus, a mobile station that is covered by the coverage of a relay simply receives a boost in signal strength.

Badruddin, N., and Negi, R., “Capacity improvement in a CDMA system using bridging,” in Wireless Communications and Networking Conference, 2004, WCNC. 2004 (IEEE, Volume: 1, 21-25Mar. 2004, Pages 243-248) proposes an enhanced relay system for CDMA based cells that also improves capacity. This paper notes that there is a significant interference problem for relays, when mobile stations (MSs) relatively near the relay are communicating directly with a more distant base station (BS) at high power. Such a situation may occur, for example, when an MS is 0.9 km from a base station while the relay is 1.0 km from the base station.

This interference impacts upon the capacity of the cell.

The paper proposes a time division multiplexing (TDM) scheme wherein for each of three timeslots, direct communicating MSs in one 120° segment of the cell and relayed MSs in an opposite 120° segment of the cell occupy one time slot, forming a ‘bow-tie’ arrangement of reciprocal segments. This maximises the distance between direct communicating MSs and active relays and so minimises the interference between them. This results in greater capacity, but has the significant disadvantage that to maintain throughput in the TDM scheme requires transmissions at three times the original data rate to allow each 120° segment to directly and indirectly communicate in sequence.

To limit this problem, the paper then suggests using six 60° segments so that, for example, in a first time slot segments 1, 3 and 5 allow direct communication, while segments 2, 4 and 6 allow relayed communication. In a second time slot, these modes swap. Whilst this preserves the notion that the opposite segment is always in the opposite mode, now the adjacent segments are also in the opposite mode and so there is less mitigation of interference at each relay, reducing the improvement in capacity. In addition, this arrangement still uses a TDM scheme, now with two time slots, and so requires a doubling in data rate to maintain throughput.

Moreover, both schemes require exact timing between MSs, relays and the base station to operate the time division multiplexing, and require a significant increase in data rate.

Alternatively or in addition to attempts to physically avoid interference as described above, a scheme to increase cell capacity may adopt an improved multiple-access coding scheme that reduces multi-user interference between signals.

An example of such a scheme is orthogonal frequency division multiplexing (OFDM). OFDM utilises a multicarrier modulation scheme wherein sets of parallel symbols are transmitted on corresponding sets of subcarriers within a baseband channel. By setting the symbol length appropriately, the frequency response of the subcarriers can be controlled to minimise cross interference between the carriers, rendering them orthogonal and allowing efficient use of the available spectrum. In OFD Multiple Access (OFDMA), multiple access is achieved by allocating one or more subcarriers to data from different users.

For convenience, the set of subcarriers assigned to one user is referred to hereafter as a subchannel. Numerous strategies for allocating subcarriers to subchannels can be envisaged, including using contiguous blocks of subcarriers, a pseudo-random selection of subcarriers, or set patterns of subcarriers.

Distributing a subchannel over a diverse set of sub-carriers is analogous to the code-spreading operation employed by code division multiple access (CDMA), and mitigates intra-cell interference. By similar analogy, having each cell map sets of subcarriers for each subchannel differently is akin to the code-scranbling operation employed in CDMA, and mitigates inter-cell interference.

However, unlike CDMA, OFDMA advantageously yields a processing gain on the uplink, as mobile stations transmitting on an uplink to a base station are able to concentrate their transmit power in that fraction of the total bandwidth so allocated to them. The result is a more efficient use of mobile station resources. Similarly, while CDMA must use comparatively inflexible orthogonal variable spreading factors to accommodate users with different throughput requirements, in OFDMA users with higher throughput requirements can simply be allocated a plurality of subchannels.

FIG. 2 illustrates a trivial example of pseudo-random subcarrier allocation between four subchannels for two adjacent cells, i & j. One can see that the vast majority of subcarriers are allocated to different subchannels within the different cells. However, in this case, corresponding allocations have occurred for three carriers, as identified by the dashed lines.

It will be appreciated that where tens or hundreds of subchannels are allocated within an OFDMA scheme, the proportion of corresponding allocations that occur between two cells will reduce accordingly. However, in a typical cellular network, a cell may actually have six immediate neighbours, and the level of subcarrier interference will therefore scale according to the frequency re-use factor amongst these cells.

Attempts to improve uplink throughput within cells have been proposed. In Anghel, P. A. Kaveh, M. “Relay assisted uplink communication over frequency-selective channels,” 4^{th} IEEE Workshop on Signal Processing Advances in Wireless Communications (2003), a system analogous to co-operative CDMA was proposed based upon block-OFDMA, wherein fixed relays within the cell retransmit signals sent from MSs to a base station. The base station thus receives two or more diverse versions of the uplink signal from the MS and one or more relays, mitigating the effects of flat fading in any given channel. However, the relays share the bandwidth of the MSs in the cell, and so their effectiveness becomes limited as cell utilisation increases.

In Guoqing Li and Hui Liu, “On the Capacity of the Broadband Relay Networks”, Thirty-Eighth Annual Asilomar Conference on Signals, Systems, and Computers, Nov. 2004, Asilomar, Calif., (soft published at http://danube.ee.washington.edu/downloadable /gli/1263.pdf), amplify-and-forward (AF) and decode-and-forward (DF) relay schemes are investigated for OFDM and OFDMA systems, wherein again the base station receives a direct transmission from the MS and one or more diverse copies from relay stations employing one of the above relay schemes. The paper provides guidance as to which relay schemes work best for different relay power levels for OFDM and OFDMA.

However, there appears to be scope for an improved approach to orthogonal frequency division communications, based upon reducing interference through cell architecture, data allocation techniques, or an interaction of the two.

The present invention intends to provide such an approach.

In a first aspect of the present invention, a cellular base station is arranged in operation to communicate directly with mobile stations that are located within an inner zone of a cell, where said inner zone is substantially defined by a circumference formed by a plurality of bridging stations deployed about said base station, and wherein the base station is further operable to communicate via said bridging stations with mobile stations located within an outer zone of the cell lying predominantly outside said circumference, said base station being arranged in operation to assign duplicate OFDMA sub-channels to mobile stations in respective areas of the outer zone served by

bridging stations that experience sufficiently low levels of cross-interference from each other's communications.

In another aspect of the present invention, a base station is arranged in operation to communicate directly with mobile stations that are located within an inner zone of a cell, where said inner zone is substantially defined by a circumference formed by a plurality of bridging stations deployed about said base station, and wherein the base station is further operable to communicate via said bridging stations with mobile stations located within an outer zone of the cell lying predominantly outside said circumference, said base station being arranged in operation to utilise distinct OFDMA sub-carrier to sub channel mappings for two or more respective areas of the outer zone served by respective bridging stations.

In an aspect of the present invention, a bridging station comprises one or more directional antennas operable to generate a coverage area in an outer zone, the outer zone lying predominantly outside a circumference defined with respect to a base station and approximately coincident with said bridging station, the bridging station being arranged in operation to retransmit OFDMA subchannels assigned to MSs within its coverage area.

In an aspect of the present invention, a bridging station comprises one or more directional antennas operable to generate a coverage area in an outer zone, the outer zone lying predominantly outside a circumference defined with respect to a base station and approximately coincident with said bridging station, the bridging station being arranged in operation to re-map OFDMA subcarriers to a subchannel mapping associated with the bridging station's coverage area.

In an aspect of the present invention, a bridging station comprises one or more directional antennas operable to generate a coverage area lying predominantly outside a circumference, said circumference defined with respect to a base station, the coverage area extending sufficiently close to said base station that an overlapping portion of the coverage area is also served by the base station, so forming an intermediate zone wherein an MS will receive signals from both the base station and the bridging station, the bridging station being operable to retransmit signals for OFDMA subchannels assigned to MSs within its coverage area.

In an aspect of the present invention, a communication network comprises at least a first region serviced by a base station, the base station being additionally surrounded by a plurality of bridging stations so defining a circumference approximately coincident with said bridging stations, the bridging stations being directionally sensitive beyond said circumference with respect to the base station, so forming an inner zone predominantly within the circumference that is serviced by the base station, and an outer zone predominantly beyond the circumference serviced by the plurality of bridging stations, and wherein the base station is operable to assign duplicate OFDMA sub-channels to mobile stations in respective areas of the outer zone served by bridging stations that experience sufficiently low levels of cross-interference from each other's communications.

In an aspect of the present invention, a communication network comprises at least a first region serviced by a base station, the base station being additionally surrounded by a plurality of bridging stations so defining a circumference approximately coincident with said bridging stations, the bridging stations being directionally sensitive beyond said circumference with respect to the base station, so forming an inner zone predominantly within the circumference that is serviced by the base station, and an outer zone predominantly beyond the circumference serviced by the plurality of bridging stations, and wherein the base station is operable to utilise distinct OFDMA sub-carrier to sub channel mappings for two or more respective areas of the outer zone served by respective bridging stations.

In a configuration of either of the preceding two aspects, the communication network comprises a plurality of regions as described by the respective aspect, wherein the subchannels assigned to outer zones take account of existing mappings used in adjacent outer zones of neighbouring cells, in order to reduce inter-cell interference.

In a configuration of either of the two preceding aspects, the coordination of mappings between neighbouring cells is conducted by the base stations of those cells.

In another configuration of either of the two preceding aspects, the coordination of mappings between neighbouring cells is conducted by a network management unit.

In an aspect of the present invention, a data carrier comprises computer readable instructions that when interpreted by a computer, cause it to operate as a base station as disclosed herein.

In another aspect of the present invention, a data carrier comprises computer readable instructions that when interpreted by a computer, cause it to operate as a bridging station as disclosed herein.

In another aspect of the present invention, a data carrier comprises computer readable instructions that when interpreted by a computer, cause it to operate as a component of a communications network as disclosed herein.

Embodiments of the present invention will now be described by way of example with reference to the accompanying drawings, in which:

FIG. 1 is a schematic diagram of a 3G cellular network and resulting coverage scheme known in the art.

FIG. 2 is a schematic diagram of OFDMA subcarrier to subchannel mapping known in the art.

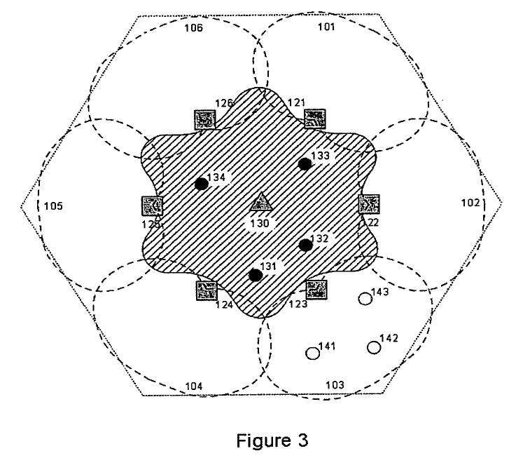

FIG. 3 is a schematic diagram of a base station and bridging stations in accordance with an embodiment of the present invention illustrating the resulting areas of coverage.

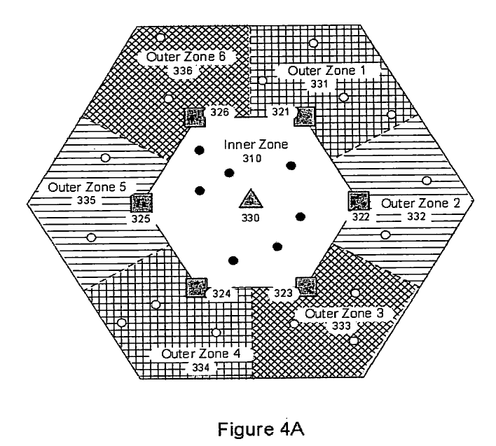

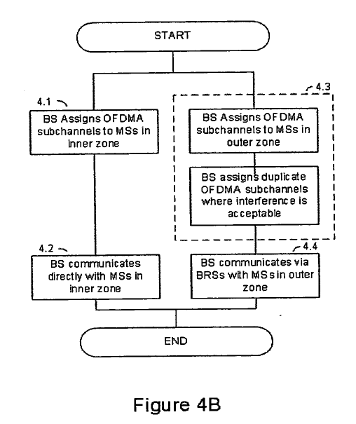

FIG. 4A is a schematic diagram of a base station and bridging stations in accordance with an embodiment of the present invention, illustrating OFDMA subchannel deployment in accordance with an embodiment of the present invention.

FIG. 4B is a flow diagram of a method of communication in accordance with an embodiment of the present invention.

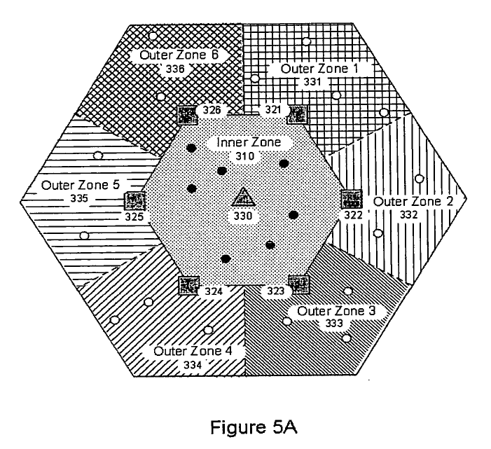

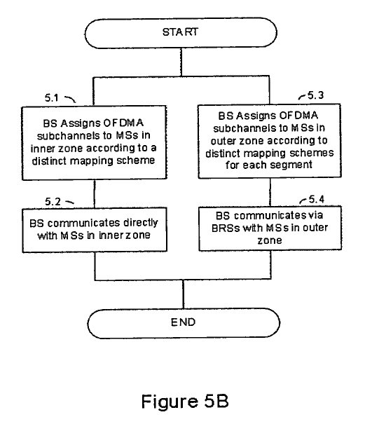

FIG. 5A is a schematic diagram of a base station and bridging stations in accordance with an embodiment of the present invention, illustrating OFDMA subchannel deployment in accordance with an embodiment of the present invention.

FIG. 5B is a flow diagram of a method of communication in accordance with an embodiment of the present invention.

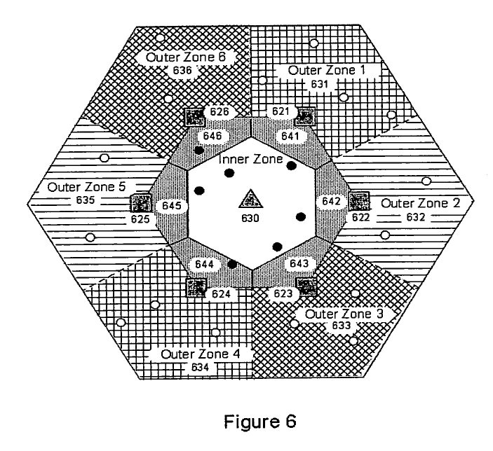

FIG. 6 is a schematic diagram of a base station and bridging stations in accordance with an embodiment of the present invention, illustrating OFDMA subchannel deployment in accordance with an embodiment of the present invention.

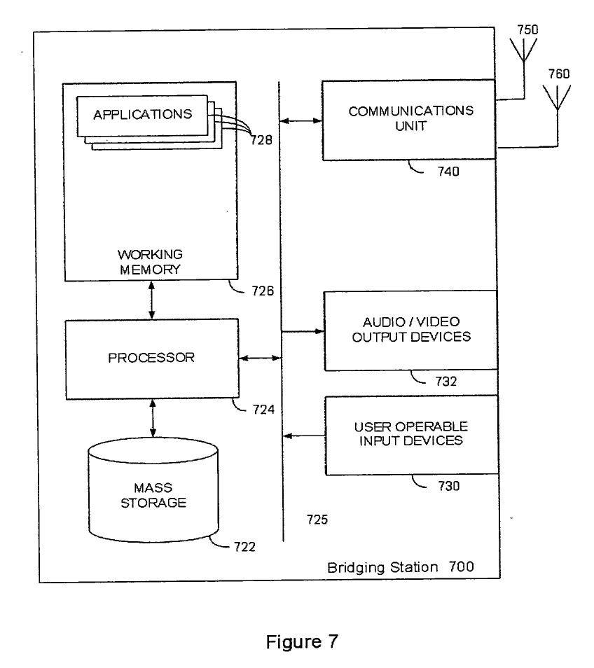

FIG. 7 is a schematic diagram of a bridging station in accordance with an embodiment of the present invention.

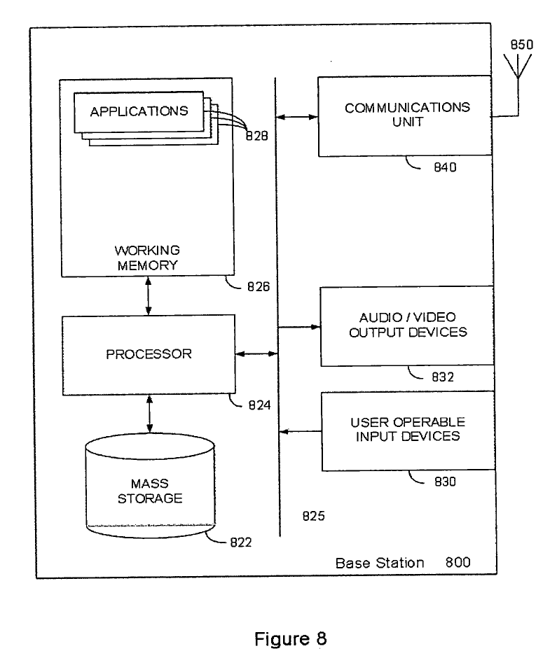

FIG. 8 is a schematic diagram of a base station in accordance with an embodiment of the present invention.

A wireless communication system is disclosed. In the following description, a number of specific details are presented, by way of example, in order to provide a thorough understanding of embodiments of the present invention. It will be apparent, however, to a person skilled in the art that these specific details need not be employed to practice the present invention.

Referring now to FIG. 3, in an embodiment of the present invention, a new cell architecture comprises a base station (BS) 130 connected to the cellular network backbone (not shown), for example via a wireline connection to a mobile switching centre (not shown). Deployed at a distance around the base station (BS) are bridging stations (BRS) 121-126 that are not connected to the backbone.

The bridging stations 121-126 comprise beam-forming antenna arranged to provide communication in a substantially outward direction in relation to the base station 130. Thus each bridging station provides a respective outward facing coverage area 101-106.

In consequence, mobile stations (MS) 131-134 located between the base station and the deployed bridging stations only perceive the base station 130 and so communicate with it directly.

In contrast, mobile stations 141-143 located beyond the deployed bridging stations, but within one of the outward facing coverage areas 101-106, perceive both the BS 130 and one or more BRSs, but select the BRS with the strongest signal (for example, on an broadcast channel) with which to communicate.

The effect is to create two zones within the cell; an inner zone where an MS only sees the base station and so communicates directly with it (denoted by the hatched area in FIG. 3), and a segmented outer zone comprised of coverage areas 101-106 where an MS elects to communicate with a respective bridging station.

Advantageously, the directionality of the bridging stations 121-126 means that not only do MSs in the inner zone not detect the bridging stations, but the bridging stations 121-126 also do not detect MSs from the inner zone, and so do not suffer interference from these MSs.

Similarly advantageously, MSs in the outer zone will adjust their power output to communicate with the closest BRS, and so minimise the interference they cause at the BS 130 and to other BRSs.

Thus, a significant overall reduction in interference and corresponding increase in capacity is achieved without the disadvantages of either time division multiplexing or hierarchical arrangements of sub-cells, as experienced in the prior art.

It will be understood that in practice, some incidental signals from each zone may be perceived in the other. For example, a (heavily attenuated) signal from an MS in the inner zone may reach a BRS due to back-scattering by a building in the outer zone. Similarly, whilst most directional antennas are predominantly sensitive in the preferred range of direction, there may be residual sensitivity in other directions. Thus a BRS may detect an MS from the inner zone, but at a significantly attenuated sensitivity when compared to an MS in its own outward facing coverage area. Conversely an MS in the inner zone may detect a BRS, but as a comparatively faint signal.

Thus in practice, the bridging stations can be thought of as being deployed to form a circumference about the base station, wherein the bridging station signal strength within the circumference is insignificant, and wherein a bridging station's signal strength outside the circumference is predominant within each respective bridging station's coverage area. Consequently, the area within the circumference forms the inner zone, and the bridging station coverage areas form the outer zone.

In an embodiment of the present invention, the bridging stations 121-126 facilitate communication between an MS in the outer zone and the BS 130 in the inner zone by acting as if part of a multi-hop network, allowing communication between the MSs in the outer zone and the BS 130 via hops to the relevant BRS. Mechanisms for establishing multi-hop networks are well known in the art. Due to the fixed nature of the bridging stations, however, it is anticipated that only two hops (from MS to BRS and from BRS to BS) are necessary.

The beneficial reduction in interference caused by creating an inner and segmented outer zone within the cell advantageously allows for a significant increase in overall capacity when using OFDMA techniques.

FIG. 4A is a schematic representation of the arrangement shown in FIG. 3, presented for clarity. The arrangement again comprises an inner zone 310 and six segments of the outer zone 331-336, served by corresponding bridging stations 321-326.

In an embodiment of the present invention, a common subcarrier-to-subchannel mapping is applied throughout the cell. However, the segmentation of the outer zone by the bridging stations allows the segregation of subchannels on a segment-by-segment basis, enabling re-use of the subchannels in non-adjacent segments.

Referring now to FIG. 4A, an example segregation is shown wherein the segments of the outer zone are shaded as opposing pairs (331, 334), (332, 335), (333, 336). These opposing pairs will experience the smallest cross-interference within the cell, as they direct their coverage away from each other and are also physically separated by the diameter of the inner zone 310.

Thus, in this example, the base station assigns the same sub-channels to MSs in each opposing pair of segments. If all the MSs were in the outer zone, this would have the potential to double the capacity within the cell. In general however, a proportion of subchannels are assigned within the inner zone and so cannot be doubled up. Thus, the potential capacity relationship is 2N−M, where N is the total number of subchannels in the OFDMA mapping, and M is the number of those subchannels being used by MSs in the inner zone that communicate directly with the BS.

Advantageously, in an embodiment of the present invention, each BRS will only need to retransmit to their coverage area a fraction of the total number of subcarriers within the baseband, corresponding to the subchannels of MSs within the BRSs coverage area with which they are communicating.

In one embodiment, the BRSs use amplify-and-forward retransmission. In an alternative embodiment, the BRSs use a decode-and forward method.

In addition to the reduction in overall power requirement (or, conversely, boost to signal power for same overall consumption) that retransmitting only a fraction of the subcarriers provides, it also reduces the inter-cell interference caused between adjacent cells, as the likelihood of interference occurring is proportional to the fraction of baseband in use.

Indeed, in an embodiment of the present invention, a communications system comprises means to coordinate the assignment of subchannels within segments of the outer zones of neighbouring cells so as to also reduce the likelihood of adjacent segments of neighbouring cells using the same subcarriers. Such coordination may be achieved directly between neighbouring base stations or by the supervision of a communications network control unit.

It will be appreciated that MSs in the outer zones may receive signals from both their respective BRS and the BS itself. In this circumstance, the BS signal will be delayed and attenuated compared with that from the BRS, and so resemble a multipath propagation echo. However, OFDM modulation incorporates a guard interval that can accommodate such multipath effects, at some cost to overall throughput.

Referring now to FIG. 4B, the corresponding method of communication comprises the steps of:

| | |
|---|---|
| s4.1 | the BS assigning OFDMA subchannels for |
| | direct communication with MSs in the inner zone; |
| s4.2 | the BS communicating |
| | with MSs in the inner zone directly; |
| s4.3 | the BS assigning OFDMA subchannels for |
| | communication with MSs in the outer zone, |
| | including duplicate subchannels in sufficiently non- |
| | interfering segments of the outer zone (excluding |
| | those in use within the inner zone), and; |
| s4.4 | the BS communicating with MSs |
| | in the outer zone via a respective BRS. |

Referring now to FIG. 5A, in an embodiment of the present invention, different subcarrier-to-subchannel mappings are applied throughout the cell for different zones and segments. FIG. 5A shows an example segregation wherein the inner zone and the segments of the outer zone are shaded individually.

In an embodiment of the present invention, the inner zone and each segment 331-336 of the outer zone use a different subcarrier-to-subchannel mapping, potentially allowing each to fully utilise all the subchannels in the system.

In consequence, the BRSs may need to re-map the BS signals they receive before forwarding them to their respective coverage areas, depending upon the method of BS to BRS communication used.

It will be appreciated that by using different subcarrier to subchannel mappings, there is increased scope for interference of the form described with respect to FIG. 2. Advantageously, however, the directional nature of the BRSs limits the scope for such interference between the inner and outer zones.

Referring now to FIG. 5B, the corresponding method of communication comprises the steps of:

| | |
|---|---|
| s5.1 | the BS assigning OFDMA subchannels |
| | for direct communication with |
| | MSs in the inner zone using a first |
| | subcarreir to subchannel mapping; |
| s5.2 | the BS communicating with MSs |
| | in the inner zone directly; |
| s5.3 | the BS assigning OFDMA subchannels for |
| | communication with MSs in the outer zone, utilising |
| | different subcarrier to subchannel mappings for |
| | each respective segment of the outer zone, and; |
| s5.4 | the BS communicating with MSs |
| | in the outer zone via a respective BRS. |

Again, in an embodiment of the present invention, mappings can be coordinated between neighbouring cells to minimise interference at adjacent outer segments.

It will be apparent to a person skilled in the art that the methods detailed in reference to FIGS. 4B and 5B may optionally be combined, such that, for example, a single subcarrier to subchannel mapping is re-used for preference in order to limit interference between sub-channels within the cell, but additional mappings may be introduced where or when mobile demand is very high. Thus, for example, the method of 5B may effectively be used at times of peak traffic, and the method of 4B at other times.

Referring now to FIG. 6, in an alternative embodiment of the present invention, the directionality of bridging stations 621-626 demonstrates some appreciable inward facing transmission and reception sensitivity. The result is that the coverage zone of each bridging station now comprises outer zones 631-636 and corresponding intermediate diversity zones 641-646, surrounding a reduced inner zone. The diversity zones represent those areas of the cell where an erstwhile inner zone mobile station will now receive significant signals from both the BS and their respective BRS, (typically offset in time), but where the OFDMA modulation scheme allows these two signals to be exploited as diversity sources rather than interfering sources, so improving reception. It will be clear to a person skilled in the art that this assumes a common subcarrier to subchannel mapping is used within the cell, and that the relevant BRS is set to retransmit subchannels for MSs within their respective diversity zone.

It will be appreciated that whilst in FIGS. 3, 4A, 5A and 6, six bridging stations are shown evenly distributed and each covering an area of similar size, in practice any suitable number of bridging stations may be deployed and may have substantially outward looking coverage areas applicable to the topology and traffic requirements within the overall cell region. Thus the circumference identifying the inner and outer zones may be arbitrary in shape, and the density of bridging stations may vary to create micro-cell and pico-cell sized coverage zones where applicable.

In consequence, it will apparent to a person skilled in the art that duplicate OFDMA subchannels can be assigned to segments of the outer zone that are not in exact opposition to each other (for example, where there are an odd number of bridging stations, or one comparatively large outer zone segment is in diametric opposition to two relatively small outer zone segments).

Thus, in an embodiment of the present invention, the base station is free to assign duplicate OFDMA subchannels in respective outer zone segments that have sufficiently low levels of cross-interference, and is not restricted merely to opposing segments.

Similarly, in an embodiment of the present invention, it is not necessary for the coverage area of the BS to be maintained so as to match the extent of the cell, as the BRSs provide communication links with MSs in the outer zone. In consequence, the base station power management may be configured to provide the smallest coverage area that maintains continuity of coverage with the plurality of bridging stations.

Advantageously, this may also allow a reduction in the length of guard interval required to accommodate the apparent multipath effect of receiving corresponding BRS and BS transmissions at an MS in the outer zone as noted previously, as this effect will be greatly reduced.

Referring now to FIG. 7, in an embodiment of the present invention, a bridging station 700 comprises a processor 724 operable to execute machine code instructions stored in a working memory 726 and/or retrievable from a mass storage device 722. By means of a general-purpose bus 725, user operable input devices 730 are in communication with the processor 724. The user operable input devices 730 comprise any means by which an input action can be interpreted and converted into data signals, for example, DIP switches.

Audio/video output devices 732 are further connected to the general-purpose bus 725, for the output of information to a user. Audio/video output devices 732 include any device capable of presenting information to a user, for example, status LEDs. The user would typically be an install/service engineer.

A communications unit 740 is connected to the general-purpose bus 725, and further connected to a first antenna or set of antennas 750. By means of the communications unit 740 and said first antenna 750, the bridging station 700 is capable of establishing wireless communication with mobile stations within it coverage area. The communications unit 740 is also connected to a second antenna or set of antennas 760. By means of the communications unit 740 and said second antenna 760, the bridging station 700 is capable of establishing communication with the base station. The communications unit 740 is operable to convert data passed thereto on the bus 725 to an RF signal carrier in accordance with a communications protocol previously established for use by a system in which the bridging station 800 is appropriate for use, for example 4G.

In the bridging station 700 of FIG. 7, the working memory 726 stores applications 7828 which, when executed by the processor 724, cause the establishment of an interface to enable communication of data to and from mobile stations and the base station. The applications 728 thus establish general purpose or specific computer implemented utilities and facilities that are used in linking mobile stations within the coverage area to the base station.

Referring now to FIG. 8, in an embodiment of the present invention, a base station 800 comprises a processor 824 operable to execute machine code instructions stored in a working memory 826 and/or retrievable from a mass storage device 822. By means of a general-purpose bus 825, user operable input devices 830 are in communication with the processor 824. The user operable input devices 830 comprise any means by which an input action can be interpreted and converted into data signals, for example, DIP switches.

Audio/video output devices 832 are further connected to the general-purpose bus 825, for the output of information to a user. Audio/video output devices 832 include any device capable of presenting information to a user, for example, status LEDs. The user would typically be an install/service engineer.

A communications unit 840 is connected to the general-purpose bus 825, and further connected to an antenna or set of antennas 850. By means of the communications unit 840 and said antenna 850, the base station 800 is capable of establishing wireless communication with mobile stations and bridging stations within its coverage area. The communications unit 840 is operable to convert data passed thereto on the bus 825 to an RF signal carrier in accordance with a communications protocol previously established for use by a system in which the base station 800 is appropriate for use, for example 4G.

In the base station 800 of FIG. 8, the working memory 826 stores applications 828 which, when executed by the processor 824, cause the establishment of an interface to enable communication of data to and from mobile stations and bridging stations. The applications 828 thus establish general purpose or specific computer implemented utilities and facilities that are used in linking mobile stations and bridging stations to the base station.

In an alternative embodiment, base station 800 comprises a further antenna or set of antennas for communication specifically with BRSs.

It will be appreciated that the use of bridging stations in conjunction with OFDMA scheme provides a number of advantages.
i. The topological differentiation of users by the use of bridging stations physically substantially isolates signals in separate outer zone segments. Consequently OFDMA subcarrier to subchannel mappings may be re-used in these segments, so potentially doubling capacity.
ii. Similarly the topological differentiation of users by the use of bridging stations physically substantially isolates signals between the inner and outer zones and within segments of the outer zones. Consequently distinct OFDMA subcarrier to subchannel mappings may be used in these areas, significantly increasing capacity.
iii. The topological differentiation of users by the use of bridging stations physically substantially isolates signals in separate outer zone segments. Consequently, OFDMA subchannels can be coorinated more finely both within and between cells, reducing intra and inter cell interference.

Each of these advantages, taken separately or in combination, serves to improve the capacity and flexibility of cells using OFDM and OFDMA communication.

It will be clear to a person skilled in the art that OFDM and OFDMA are umbrella terms for orthogonal frequency division multiplexing techniques and OFDM access in general, and encompass variants such as coded-OFDM or block-OFDM.

Similarly, it will be clear to a person skilled in the art that the present invention is suited to other wireless architectures where mobile communications devices link to a central station that in turn links to a wireline infrastructure, such as wireless local loop.

It will be clear to a person skilled in the art that embodiments of the present invention may be implemented in any suitable manner to provide suitable apparatus or operation;

Thus, a base station may consist of a single discrete entity, multiple entities added to a conventional host device such as a computer, or may be formed by adapting existing parts of a conventional host device such as a computer. Alternatively, a combination of additional and adapted entities may be envisaged. For example, components used in the manufacture of base stations may be used in the construction of bridging stations when suitably reconfigured. Thus adapting existing parts of a conventional device may comprise for example reprogramming of one or more processors therein. As such the required adaptation may be implemented in the form of a computer program product comprising processor-implementable instructions stored on a storage medium, such as a floppy disk, hard disk, PROM, RAM or any combination of these or other storage media or signals.

1. A base station for wireless communication arranged in operation to directly communicate with mobile stations located within an inner zone of a cell, the inner zone lying predominantly within a circumference formed by a plurality of bridging stations deployed around said base station, the base station further arranged in operation to indirectly communicate via said bridging stations with mobile stations located within an outer zone of the cell lying predominantly outside said circumference, said base station being arranged in operation to assign duplicate OFDMA subchannels to mobile stations in respective areas of the outer zone served by bridging stations that experience sufficiently low levels of cross-interference from each other's communications.

2. A base station for wireless communication arranged in operation to directly communicate with mobile stations located within an inner zone of a cell, the inner zone lying predominantly within a circumference formed by a plurality of bridging stations deployed around said base station, the base station further arranged in operation to indirectly communicate via said bridging stations with mobile stations located within an outer zone of the cell lying predominantly outside said circumference, said base station being arranged in operation to utilise distinct OFDMA subcarrier to subchannel mappings for two or more respective areas of the outer zone served by respective bridging stations.

3. A bridging station for wireless communication comprising one or more directional antennas operable to generate a coverage area lying predominantly outside a circumference, said circumference defined with respect to a base station and substantially coincident with said bridging station, and wherein the bridging station is operable to retransmit OFDMA subchannels assigned to MSs within its coverage area.

4. A bridging station for wireless communication comprising one or more directional antennas operable to generate a coverage area lying predominantly outside a circumference, said circumference defined with respect to a base station and substantially coincident with said bridging station, and wherein the bridging station is operable to re-map OFDMA subcarriers to a subchannel mapping associated with the bridging station's coverage area.

5. A bridging station for wireless communication comprising one or more directional antennas operable to generate a coverage area lying predominantly outside a circumference, said circumference defined with respect to a base station, and sufficiently close to said base station that an overlapping portion of the coverage area is also served by the base station, so forming an intermediate zone wherein an MS will receive signals from both the base station and the bridging station, the bridging station being operable to retransmit signals corresponding to OFDMA subchannels assigned to MSs within its coverage area.

6. A communication network comprising at least a first region serviced by a base station, and further comprising a plurality of bridging stations deployed around the base station so defining a circumference about said base station, wherein each bridging station comprises one or more directional antennas operable to generate a coverage area lying predominantly outside said circumference, so forming in operation an outer zone predominantly outside said circumference and serviced by said bridging stations, and an inner zone predominantly within said circumference and serviced by said base station, and wherein said base station is arranged in operation to assign duplicate OFDMA sub-channels to mobile stations in respective areas of the outer zone served by bridging stations that experience sufficiently low levels of cross-interference from each other's communications.

7. A communication network comprising at least a first region serviced by a base station, and further comprising a plurality of bridging stations deployed around the base station so defining a circumference about said base station, wherein each bridging station comprises one or more directional antennas operable to generate a coverage area lying predominantly outside said circumference, so forming in operation an outer zone predominantly outside said circumference and serviced by said bridging stations, and an inner zone predominantly within said circumference and serviced by said base station, and wherein said base station is arranged in operation to utilise distinct OFDMA sub-carrier to sub channel mappings for mobile stations in two or more respective areas of the outer zone.

8. A communication network in accordance with claim 6, wherein the communication network comprises at least two neighbouring regions similarly serviced by a base station and plurality of bridging station, wherein the subcarrier to subchannel mappings used in adjacent outer zones are coordinated between cells such that they reduce the number of subcarriers used in common between said adjacent outer zones.

9. A communication network in accordance with claim 8 wherein neighbouring base stations manage their co-ordination.

10. A communication network in accordance with claim 8 wherein the co-ordination is supervised by a network control unit.

11. A data carrier comprising computer readable instructions that, when loaded into a computer, cause the computer to operate as a base station in accordance with claim 1.

12. A data carrier comprising computer readable instructions that, when loaded into a computer, cause the computer to operate as a bridging station in accordance with claim 3.

13. A data carrier comprising computer readable instructions that, when loaded into a computer, cause the computer to operate as a component of a communications network in accordance with claim 6.
